(19) United States
(12) Patent Application Publication
(10) Pub. No.: US 2020/0272988 A1
(43) Pub. Date: Aug. 27, 2020

(54) Methods to Facilitate the Relationship Between Practitioners, Clients, and Vendors

(71) Applicant: CAO Group, Inc., West Jordan, UT (US)

(72) Inventors: Steven D. Jensen, South Jordan, UT (US); Densen Cao, Sandy, UT (US)

(21) Appl. No.: 16/795,336

(22) Filed: Feb. 19, 2020

Related U.S. Application Data
(60) Provisional application No. 62/807,443, filed on Feb. 19, 2019.

(51) Int. Cl. G06Q 10/08

(52) U.S. Cl. CPC G06Q 10/0835; G06Q 10/087; G06Q 10/0832

(57) ABSTRACT

Relations between practitioners, vendors, and clients are enhanced by privately labeled products which may be provided to practitioners of various health-related fields to direct sale to their patients and clients. In this way, good will associated with the product inures to the practitioner. Reordering of additional product may be accomplished with either the practitioner being the sole source of the product or by the manufacturer providing the privately branded product to the patient. The use of an app or website may facilitate not only reordering and placing subscription orders of product, but also track client care progress and foster communication between practitioners, clients, and vendors.

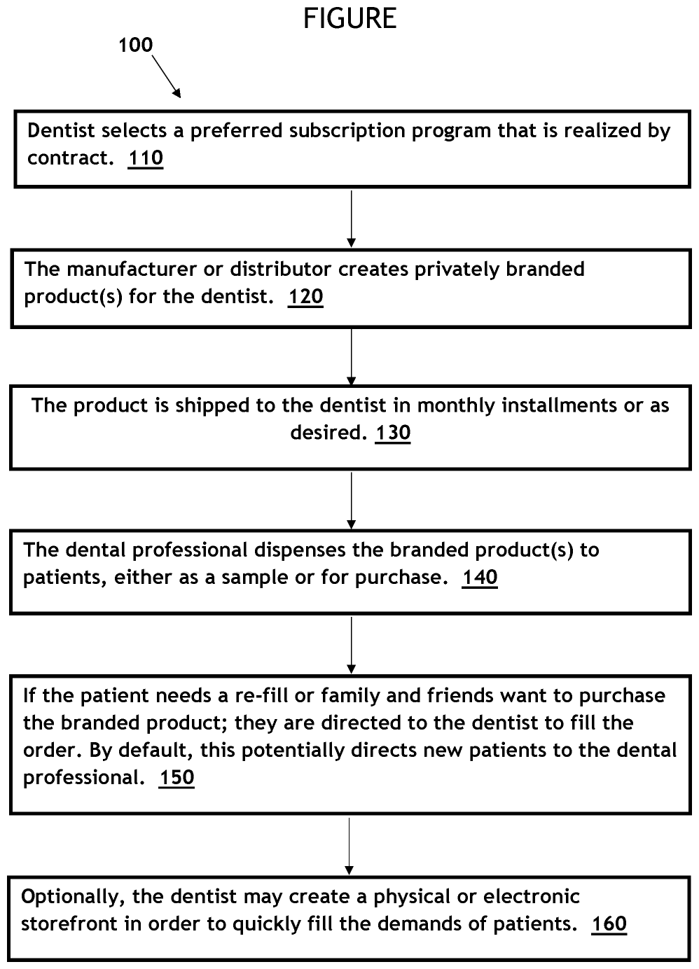

### CROSS-REFERENCES TO RELATED APPLICATIONS

This application claims priority as a non-provisional perfection of prior filed U.S. App. No. 62/807,443, filed Feb. 19, 2019, and incorporates the same by reference herein in its entirety.

### FIELD OF THE INVENTION

The present invention relates to the field of business methods and more particularly relates to a method to generate sales subscriptions for privately branded products to patients.

### BACKGROUND OF THE INVENTION

Oral care is an essential part of human daily life routine to maintain oral and body health. Multiple products are used in daily oral care activities by consumers. While many consumers buy oral care products from retail outlets, it is common practice in dental offices to provide various prescription and non-prescription dental products that are designed for the patient to take home as part of a treatment regime. These products are purchased from commercially available manufacturers or distributors that label the packages with their own logo and marketing information. The purpose is to drive sales back to the manufacturer or distributor in the event of a patient re-order. It also provides word-of-mouth marketing for the manufacturer—if patients like the product they often tell family and friends who then purchase the product from information garnered from the package and packaging materials.

The present invention discloses subscription methods that are designed to give dental practitioners their own privately branded dental products; wherein they promote their own dental practice/office instead of a manufacturer or commercially labeled products. The present invention represents a departure from the prior art in that the method of the present invention allows for patient association and development of good will to inure to the benefit of the practitioner rather than a third-party manufacturer, strengthening the patient/practitioner relationship. It is also a function of this invention to foster the care given to patients or clients by practitioners, such as by dentists to patients, by providing an avenue to better manage the patient's or client's treatment plan. The method may also form vendors, practitioners, and patients into interactive triangles to benefit all three parties, with the most important benefit being that patient gets true oral care based on a diagnosed oral condition.

### SUMMARY OF THE INVENTION

In view of the foregoing disadvantages inherent in the known methods of providing dental or other medical products to patients an improved method may provide good will to the practitioner and enhance the practitioner/patient relationship. Such a method should meet the following objectives: that it be easy to implement, that it effectively associate the treatment products with the practitioner and not the manufacturer, that it be efficient in fulfilling demand so as to not damage the good will, and that it fosters interaction between the practitioner and client to further treatment plans and other client goals. The present invention is intended to produce products labeled with the practitioner's customized marketing information on the package in order to drive future sales back to the practitioner instead of to a manufacturer or distributor. If in the event a patient needs to reorder product, they are directed back to the practitioner to fill the order. Word of mouth marketing is then also directed to the practitioner. As such, a new and improved method may comprise contractual relationships between the practitioner and manufacturer, electronic sales interfaces, and material and marketing support from the manufacturer to the practitioner in order to accomplish these objectives.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWING

The FIGURE is a flowchart depicting a basic embodiment of the method.

### DETAILED DESCRIPTION OF THE PREFERRED EMBODIMENT

With reference now to the drawings, a preferred embodiment of the method of creating sales subscriptions that supply privately branded goods and services to dental practitioners is herein described. It should be noted that the articles “a”, “an”, and “the”, as used in this specification, include plural referents unless the content clearly dictates otherwise. The preferred embodiment is described as occurring in the field of dentistry, where the dentist is the practitioner. It should be understood that the method may be accomplished in other fields, such as medicine, with different practitioners, such as doctors, and the use of the term “dentist” or related terms should not be seen as limiting the practice of the invention to only the field of dentistry. A practitioner should be read as including any professional whose practice involves the treatment of patients or clients and their physical conditions in order to optimize health of the patient or client. Practitioners may include, but not be limited to, dentists, doctors, physical therapists, massage therapists, nutritionists, dietitians, chiropractors, and other such professionals.

With reference to the FIGURE, the basic method 100 begins when a practitioner, such as a dentist, selecting a subscription program offered by a manufacturer (or “private label vendor” or “vendor”) for privately branded products 110. The preferred embodiment of the invention utilizes a subscription or a contractual agreement in order to manage the economically feasible quantity and shipment of orders to the practitioner. An economically feasible quantity is defined as a minimum order quantity that is enough to off-set costs and at the very least generate profit. This is the reason the subscription is the preferred model as the cost can be amortized over time. Multiple options are possible within the subscription or contract with respect to installments—they can be monthly, quarterly, bi-annually, etc. The dentist may determine the shipping schedule as well, as inventory warrants.

After a subscription is in place, the manufacturer then creates privately branded products for the practitioner 120. These products may be any product relevant to the care of the patients. In the field of dentistry, this may include but not be limited to toothpastes, mouthwashes, fluoride treatments, bleaching treatments, gingival treatments, halitosis treatments, denture adhesives and cleaners, or any other product the dentist would like to provide. Of course, different practitioners may require different products (e.g. a nutritionist may require vitamin supplements). The manufacturer may then provide training and education materials to both the practitioner and staff, and also materials for patients and clients, as to the intended and proper use of the products for treatment and meeting client goals.

The brand may incorporate any known branding element. Elements may include, but are not limited to: the name of the practitioner's office, the name of the practitioner, the title of the practitioner, the address of the practitioner's office, a representative logo of the practice, a preferred color scheme of the label, a preferred color scheme of the product packaging material, a preferred style and shape of packaging, and a preferred material type that comprises the body of the package.

Products may then be shipped to the practitioner 130. The practitioner then dispenses product to patients according to treatment plan and sales model 140 and refills are then directed back to the practitioner 150, as are any referrals by patients to family or friends. The practitioner may also create an electronic storefront (or may utilize a template storefront provided by the manufacturer) to help drive resales 160. It should be noted that an electronic storefront could lead to product being shipped directly to the patient. In such an event, the manufacturer could also directly ship product, branded with the practitioner's branding, to the patient. In such an event, the practitioner is notified that a transaction has occurred with a contractual portion of sales credited to the practitioner's account.

An embodiment of the present invention incorporates a physical or electronic storefront for practitioners to adequately supply the demands of their patients. The practitioner may desire a physical sales channel with kiosks or product display shelves in the waiting room; therein the patient can browse and shop at their convenience without sales pressure from the staff or the dentists. It is desired that the practitioner utilizes all marketing channels to better serve patients; having both a physical and electronic showcase for branded products is preferred.

The practitioner may desire to sell these products to their patients one-on-one as part of a customized treatment regime in order to more easily explain their function and directions for use. The practitioner may suggest, subscribe or prescribe a treatment regime that is customized for each patient that include branded products, this may be in written or printed form; it also could be in the form of an app that is downloaded onto a patient's personal communication device. The practitioner may also opt to relegate the sales to staff members that have more time and are already in the front office while the patients are waiting.

The practitioner may desire to market and sell their branded products electronically via a website, Bluetooth connection, drop box, cloud, sync, apps, etc. to their personal communication device.

Another embodiment of the present invention is designed to provide the material and marketing support for the dental office; providing portable kiosks, display shelves, kiosks, brochures, handouts, whitepapers, samples, posters, etc. in order to showcase the items for retail sell. The manufacturer or distributor, in cooperation with the subscribing practitioner, would decide these options within the formal contract or thereafter. The manufacture and distributors may decide to provide the marketing materials free of charge as an incentive for the practitioner to subscribe to the program. In-office displays such as kiosks may be “smart kiosks” which could be connected electronically to the vendor and allow direct ordering of product from the practitioner's office.

An app or website may be provided to further integrate a treatment plan with products that would meet client goals. Such an app or website would be accessible to the vendor, the practitioners and the client and may include many functions, including but not limited to:
a. QR code scanning function for patient to register. Each dental practice could be assigned a specific code or QR code. Once the patients used the code to download the app or on website and register in app or website, the patients will belong to the community of this specific practitioner who provides the QR code. Multiple codes can be assigned to each practice so that practice can assign a code to a corresponding staff who recommend products and the app to patients. Thus, a practice can use information on app or website to measure performance of each staff member.
b. Patient account information including patient profile, usage records, credit card info, order history, etc.
c. Patient care routines designed or recommended by practitioners based on client health or oral conditions and goals.
d. Performance chart for client and practitionerto review their activities.
e. All product information including price, video, specifications, user instructions, subscription options, etc.
f. A shopping card function to enable patient to order products online and indicating status of product ordering.
g. Access to cell phone camera to record physical conditions, including oral conditions, in video or pictures in patient record.
h. Connection with any external diagnostic tools to collect information for patient.
i. Have at least one subscription model to enable the client to subscribe for the product and auto-ship from vendor.
j. Notification function for patient, practitioner, and vendors to take proper actions.
k. A chat room or other online communication forum between vendors and clients and practitioners, including staff, and/or among friends and family of patients, which can also serve as a referral vehicle for clients to recommend said friends and family.
l. Appointment booking and calendaring.
m. Connection with different practice management software to have patient records stored in app or website.
n. An award program for patients who follow through the recommended procedures.
o. Cloud-based storage of data.
p. Any other functions that are needed to enhance vendor, practitioner, and clients' relationship.

While the one of the main tools to foster the client/practitioner relationship is the private branding of the products, such branding could be forgone and the practitioner could be considered a retailer of the vendor's goods, receiving a percentage of all sales. In such cases, individual clients could be tagged with identifying data that associates them with a specific practice so that financial and other credit is given to the practitioner for resales. The relationship could still be fostered with the general relation-building materials also described herein.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A Method providing privately branded products to practitioners for sale to their patients, the method comprising:
a first step of engaging in a time-sensitive subscription contract that when made between a private label vendor and a practitioner provides the practitioner with privately labeled products that comprise a personalized brand comprised of at least one brand elements, the brand elements being selected from the set of brand elements consisting of: the name of the practitioner office, the name of the practitioner, the title of the practitioner, the address of the practitioner's office, a representative logo of the practice, a preferred color scheme of the label, a preferred color scheme of the dental packaging material, a preferred style and shape of packaging, and a preferred material type that comprises the body of the package;
a second step delivering the privately branded products to the practitioner according to the subscription contract;
a third step of directly selling the privately branded product while a patient is in the office of the practitioner; and,
a fourth step of the patient reordering more privately branded product from the practitioner, who is the only source of said privately branded product.

2. A method providing privately branded products to practitioners for sale to their patients, the method comprising:
a first step of engaging in a time-sensitive subscription contract that when made between a private label vendor and a practitioner provides the practitioner with privately labeled products that comprise a personalized brand comprised of at least one brand elements, the brand elements being selected from the set of brand elements consisting of: the name of the practitioner office, the name of the practitioner, the title of the practitioner, the address of the practitioner's office, a representative logo of the practice, a preferred color scheme of the label, a preferred color scheme of the dental packaging material, a preferred style and shape of packaging, and a preferred material type that comprises the body of the package;
a second step delivering the privately branded products to the practitioner according to the subscription contract;
a third step of directly selling the privately branded product while a patient is in the office of the practitioner; and,
a fourth step of reselling the privately branded products by means of an electronic storefront; wherein the patient orders additional privately branded products by means of a communication device with said privately branded products shipped directly to the patient by the private label vendor; and wherein the dental practitioner is notified that a transaction has occurred with a contractual portion of sales credited to the practitioner's account.

3. A method of fostering relationships between a vendor, a practitioner, and at least one client, the method comprising:
the vendor providing product to the practitioner;
the practitioner recommending product to clients based upon client goals;
providing an app that links the vendor, practitioner, and at least one clients in communication together, said app providing at least one communicative function selected from the set of communicative functions consisting of: a QR code linking practitioner to client, storing and providing client information, storing and providing product information, storing and providing shopping loyalty information, storing and providing external diagnostic information, storing and providing product subscription information, facilitating appointment booking and calendaring, facilitating and gathering of information regarding a client's current physical condition, and providing an online communications forum in which at least two parties participate.
